(19) United States
(12) Patent Application Publication
(10) Pub. No.: US 2010/0302622 A1
(43) Pub. Date: Dec. 2, 2010

(54) DISPLAY PARTICLES FOR IMAGE DISPLAY DEVICE AND IMAGE DISPLAY DEVICE INSTALLED WITH THE SAME

(75) Inventors: Yukio Hosoya, Tokyo (JP); Okushi Okuyama, Tokyo (JP); Satoshi Uchino, Tokyo (JP); Hiroyuki Konno, Tokyo (JP); Tatsuya Nagase, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/745,448

(22) PCT Filed: Sep. 10, 2009
(86) PCT No.: PCT/JP2009/065831

§ 371 Date: May 28, 2010

(30) Foreign Application Priority Data
Sep. 12, 2008 (JP) 2008-234894

(51) Int. Cl. G02F 1/167; B32B 1/00

(52) U.S. Cl. 359/296; 428/403

(57) ABSTRACT

Display particles for use in image display devices with display particles sealed in a powdery form in the space between two substrates, at least one of which is transparent, that display an image while the display particles are moved as electric field is generated between the substrates, characterized in that the display particles contain at least base particles containing at least a resin and a colorant and inorganic fine particles added to the base particle; externally and a separation amount A of the inorganic fine particles having a primary particle size of 5 to 60 nm separated from the display particles when the particles are provided with an ultrasonic energy of 60 μA for 1 minute in aqueous polyoxyethylphenylether solution is 0.1 to 2.5 wt % with respect to the base particles, and an image display device installed with the display particles for image display devices.

### TECHNICAL FIELD

The present invention relates to an image display device displaying and erasing images repeatedly by movement of display particles in applied electric field and display particles for use in the image display device.

### BACKGROUND ART

Image display devices displaying images by movement of display particles in the gas phase have been known. Such an image display device contains powdery display particles sealed in the area between two substrates, at least one of which is transparent, and an image is displayed by movement and adhesion of the display particle onto one substrate in electric field generated between the substrates. It is possible by operation of such an image display device to display and erase images repeatedly by properly selecting the direction of the electric field, because the display particles move along with the direction of the electric field, which is formed by application of a voltage between the substrates. For that reason, there existed requirements for smooth movement of the display particles even at a low operating voltage in such image display devices. Particles constituted by base particles with inorganic fine particles, such as silica or titania, applied on the surface thereof are known as display particles for use in image display devices (Patent Documents 1 to 3). In production of such display particles, the base particles and the inorganic fine particles are agitated and mixed under relative strong conditions and thus, the inorganic fine particles are fixed on the base particles.

It is possible by using such display particles to reduce adhesive force of the display particles to the display particle-contacting surfaces of substrates. However, it was not possible to reduce operating voltage sufficiently and thus, there existed requirements for further reduction of the operating voltage. For example when the operating voltage is set to a low voltage of 100 V, the contrast of image is lowered and in particular, the contrast is lowered significantly during repeated operation.

### PRIOR ART DOCUMENT

### Patent Document

Patent Document 1: JP 2004-29699A

Patent Document 2: JP 2006-72345A

Patent Document 3: JP 2007-171482A

### DISCLOSURE OF INVENTION

### Technical Problems to be Solved

An object of the present invention is to provide display particles for image display devices that display relatively high-contrast images repeatedly, even when the operating voltage is lower, and an image display device installed with the display particles.

### Means to Solve the Problems

The present invention relates to display particles for use in image display devices with display particles sealed in a powdery form in the space between two substrates, at least one of which is transparent, that display an image while the display particles are moved as electric field is generated between the substrates, characterized in that the display particles contain at least base particles containing at least a resin and a colorant and inorganic fine particles added to the base particle externally and a separation amount A of the inorganic fine particles having a primary particle size of 5 to 60 nm separated from the display particles when the particles are provided with an ultrasonic energy of 60 μA for 1 minute in aqueous polyoxyethylphenylether solution is 0.1 to 2.5 wt % with respect to the base particles.

### EFFECT OF THE INVENTION

According to the present invention, the inorganic fine particles (external additive) added externally in display particles are effective not only in reducing adhesive force of the display particles to display particle-contacting surfaces of substrates, but also in expressing bearing effect of relaxing collisional force among the display particles. Thus, relative high-contrast images can be displayed repeatedly even when the operating voltage is relatively lower.

### BRIEF DESCRIPTION OF DRAWINGS

FIG. 1A is a schematic view illustrating an example of cross-sectional configuration of an image display device;

FIG. 1B is a schematic view illustrating another example of cross-sectional configuration of an image display device;

FIG. 2 is a schematic view illustrating an example of movement of display particles when voltage is applied between substrates;

FIG. 3 is a schematic view illustrating another example of movement of display particles when voltage is applied between substrates;

FIG. 4 is a schematic view illustrating examples of shapes of image display surfaces; and

FIG. 5 is a schematic view illustrating an example of a method of sealing the display particles.

### EXPLANATION OF REFERENCE NUMERAL

1: Base particle, 2: Resin fine particle, 3: Inorganic fine particle, 10: Image display device, 11: 12: Substrate, 15: Electrode, 16: Insulation layer, 17: Partition wall, 18: Gap, 18a: Image display surface, 21: Black display particle, and 22: White display particle.

### BEST MODE FOR CARRYING OUT THE INVENTION

### Display Particles for Image Display Devices

Display particles for image display devices according to the present invention (hereinafter, referred to simply as display particles) contains base particles and inorganic fine particles, and specifically the inorganic fine particles are added externally to the base particles.

Display particles containing inorganic fine particles less adhesive to the base particle are used in the present invention. Specifically, a separation amount A of the inorganic fine particles having a primary particle size of 5 to 60 nm (hereinafter, referred to as inorganic fine particles A) separated from the display particles when the particles are provided with an ultrasonic energy of 60 μA for 1 minute in aqueous polyoxyethylphenylether solution, is 0.1 to 2.5 wt %, preferably 0.2 to 0.6 wt %, with respect to the base particle. Such inorganic fine particles are effective not only in reducing adhesive force of the display particles to the display particle-contacting surfaces of the substrates, but also in expressing the bearing effect of relaxing collisional force among the display particles, and thus, it is possible by using such particles to display relatively high-contrast images repeatedly. An excessively lower separation amount A leads to ineffective expression of the bearing effect, resulting in increase of operating voltage and lowering of contrast. An excessively higher separation amount A leads to aggregation of the separated particles to larger particles, resulting in ineffective expression of the bearing effect. Inorganic fine particles having an excessively smaller particle size and those having an excessively larger particle size are less effective in expressing the bearing effect, thus resulting in increase of operating voltage and lowering of contrast. In the present description, the primary particle size means the particle size of primary particles, and in the present invention, inorganic fine particles A having such a primary particle size may be present in the form of aggregates, because they are pulverized relatively easily during operation of the image display device even when the inorganic fine particles A may be in the form of aggregate.

An separation amount X, which is defined as an amount of all inorganic fine particles separated from display particles when display particles are provided with an ultrasonic energy of 300 μA for 60 minutes in aqueous polyoxyethylphenylether solution, is normally 0.1 to 20 wt %, particularly 1 to 10 wt % with respect to base particles.

A ratio of separation amount A/separation amount X is preferably 0.01 to 0.99, particularly 0.05 to 0.1, for more effective expression of the bearing effect when display particles are used repeatedly.

The separation amounts A and X can be determined by the following method:

Procedure 1

An image display device is disassembled and the display particles therein are collected.

Procedure 2

20 g of the display particles are placed in a 300-cc beaker, and is mixed with 200 g of aqueous 0.2% polyoxyethylphenylether solution (dispersion medium) for sufficient wetting.

Procedure 3

Inorganic fine particles are separated in an ultrasonic homogenizer US-1200T (nominal frequency: 15 kHz, manufactured by Nippon Seiki Co., Ltd.) by ultrasonic energy for 1 minute while the ultrasonic energy is adjusted so that a volume of the ammeter indicating vibration indication value and attached to the main instrument show 60 μA (50 w).

Procedure 4

The liquid mixture is filtered though a filter paper having an opening of 1 μm under reduce pressure; the dispersion medium was removed from the obtained filtrate by evaporation; and the separated inorganic fine particles are separated and dried sufficiently.

Procedure 5

The total weight of the separated inorganic fine particles is determined, and the particle size distribution thereof is determined with Microtrac UPA-150 (manufactured by Nikkiso Co., Ltd.). The weight of inorganic fine particles having a predetermined particle size are determined from the results, and the weight of the inorganic fine particles having a primary particle size of 5 to 60 nm is designated as Wa (g). The analyzer used for measurement of particle size distribution is an instrument that can determine a particle size distribution of primary particles, even when inorganic fine particles are present in an aggregated form.

Procedure 6

A total weight of all separated inorganic fine particle, Wx (g), is determined in a manner similar to the procedures 1 to 5, except that the value of the ammeter was adjusted to 300 μA and the ultrasonic energy was applied for 60 minutes in procedure 3.

Procedure 7

The base particles obtained as the residue by filtration in procedure 6 are dried sufficiently and the weight of the base particles We (g) is determined.

Procedure 8

The separation amounts A and X to the base particles are calculated according to the following Formulae:

Separation amount A(wt %)=(Wa/Wc)×100

Separation amount X(wt %)=(Wx/Wc)×100

The inorganic fine particles A are not particularly limited, if the particles have primary particle size above, and examples thereof include metal oxides such as silicon oxide, titanium oxide, aluminum oxide, tin oxide, zirconium oxide and tungsten oxide; nitrides such as titanium nitride; titanium compounds, a mixture thereof, and the like. The inorganic fine particles A are preferably silicon oxide from the viewpoint of fluidity.

Inorganic fine particles A are preferably hydrophobic in nature for further effective reduction of adhesiveness of display particles to the display particle-contacting surface of the substrates. The hydrophobicity is provided to the inorganic fine particles by treatment thereof with a hydrophobilizing agent. The hydrophobilizing agent used is not particularly limited, and any silane-coupling agent, such as dichlorosilane, alkoxysilanes, silazane, aminosilanes and silylated isocyanates may be used. Typical examples thereof include dimethyldichlorosilane, trimethylchlorosilane, methylmethoxysilane, isobutyltrimethoxysilane, hexamethyldisilazane, ter-butyldimethylchlorosilane, vinyltrichlorosilane, vinyltrimethoxysilane, vinyltriethoxysilane, isopropyltri(N-aminoethyl-aminoethyl) titanate, aminopropyltrimethoxysilane, aminopropyl triethoxysilane, dimethylaminopropyltrimethoxysilane, diethylaminopropyltrimethoxysilane, dipropylaminopropyltrimethoxysilane, dibutylaminopropyltrimethoxysilane, monobutylaminopropyltrimethoxysilane, dioctylaminopropyldimethoxysilane, dibutylaminopropyldimethoxysilane, dibutylaminopropylmonomethoxysilane, dimethylaminophenyltriethoxysilane, (N-(2-aminoethyl)-3-aminopropyltrimethoxysilane), (3-trimethoxysilylpropyl)diethylenetriamine, bis[3-(trimethoxysilyl)propyl]ethylenediamine, trimethoxysilyl-γ-propylphenylamine, trimethoxysilyl-γ-propylbenzylamine) and the like.

The inorganic fine particles A preferably have a hydrophobicity of 30 to 99.

The hydrophobicity used is a value that is determined by the methanol wettability method. The methanol wettability is a method of evaluating the wettability with methanol. In the procedure of the method, 0.2 g of inorganic fine particles to be analyzed are weighed and added into 50 ml of distilled water placed in a beaker having an internal capacity of 200 ml. Methanol is dropped through a bullet, as the tip of which is immersed into the fluid, while the mixture is agitated slowly, until all of the inorganic fine particles are wetted. When the amount of methanol needed to wet all of the inorganic fine particles completely was designated as a (ml), the hydrophobicity is calculated according to the following Formula:

Hydrophobicity={a/(a+50)}×100

Inorganic fine particles B may be used in combination with the inorganic fine particles A. The display particles according to the present invention have a separation amount B of inorganic fine particles B which are separated when the display particles are provided with an ultrasonic energy of 60 ∥A for 1 minute in aqueous polyoxyethylphenylether solution, normally at 1 wt % or less, particularly 0.01 to 0.3 wt %, with respect to base particles. The inorganic fine particles B are made of materials similar to those of the inorganic fine particles A, except that the primary particle size is different from that of the inorganic fine particles A, and are preferably silicon oxide particles. The primary particle size of the inorganic fine particles B is normally more than 60 nm and 250 nm or less, preferably 65 nm or more and 200 nm or less. The inorganic fine particles B are preferably hydrophobic and have a hydrophobicity in the range similar to that of the inorganic fine particles A.

The separation amount B can be determined similarly to the separation amount A, except that the weight of the inorganic fine particles B having a predetermined particle size is determined from the total weight and particle size distribution of the separated inorganic fine particles.

The display particles according to the present invention can be produced by the following method (A):

Method (A);

For example, the base particles and the inorganic fine particles (a) are mixed in a mixer that can mix uniformly under relatively weak agitating force, such as Turbula mixer (manufactured by Glen Mills Inc.), Henschel Mixer (manufactured by Mitsui Miike Machinery Co., Ltd.) or Super Mixer (manufactured by Kawata MFG. Co., Ltd.), under relatively small agitation speed for relatively short mixing period (mild-condition mixing-treatment).

The inorganic fine particles (a) contains at least inorganic fine particles A having the particle size described above and further, normally the inorganic fine particles B, preferably those having an average primary particle size of 5 to 55 nm, particularly preferably 14 to 40 nm are used. It is possible to control the separation amount A by adjusting the content of the inorganic fine particles A contained in the inorganic fine particles (a). For example, increase in the content of inorganic fine particles A leads to increase in separation amount A, while decrease in the content leads to decrease in separation amount A. Use of inorganic fine particles (a) having an inorganic fine particle A content of 50 wt % or more, particularly 70 to 99 wt %, with respect to the total amount of the inorganic fine particles (a) is preferable from the viewpoint of control of separation amount A. The raw materials for the inorganic fine particles (a) are exemplified by the same materials as the inorganic fine particles A. Two or more inorganic fine particles different in average primary particle size or/and constituent material may be used as the inorganic fine particles (a).

The average primary particle size of inorganic fine particles used in the present description is the number-average particle size of primary particles (number-based median diameter (d50 diameter)), as calculated from the photographic image obtained under scanning electron microscope.

It is determined by taking a picture of particles under a scanning electron microscope “JSM-7410” (manufactured by JEOL) at a magnification of 100000 times, measuring maximum lengths of 200 particles (maximum length between any two point on the periphery of particles) and averaging them to give a number-average value as an average particle size. When the particles are observed to be present as aggregates, the particle sizes of the primary particles forming the aggregates are measured.

In particular among the mixers described above, the Turbula mixer (manufactured by Glen Mills Inc.) is a mixer using beads, and it is possible to obtain further more effective bearing effect of the inorganic fine particles A, because the mixer allows adhesion of inorganic fine particles in a primary particle form on the base particles uniformly, as it pulverizes aggregates of the inorganic fine particles.

It is also possible to control the separation amount A by adjusting production conditions, particularly mixing conditions.

Specifically, for example when the Turbula mixer (manufactured by Glen Mills Inc.) is used, the agitation speed is set to 20 to 300 rpm, preferably 50 to 250 rpm and the mixing period to 3 to 20 minutes, preferably 5 to 10 minutes, and the average particle size of the beads is 0.1 to 10 mm, preferably 0.5 to 5 mm. The separation amount A increases, when the agitation speed is reduced in the range above, the mixing period is shortened in the range above, or the average particle size of beads is increased in the range above. The separation amount A decreases, when the agitation speed is raised in the range above, the mixing period is elongated in the range above, or the average diameter of beads is shortened in the range above. When the agitation speed is too high, the mixing period too long, or the bead average particle size too small outside the ranges above, the inorganic fine particles A are fixed onto the base particle relatively tightly, resulting in decrease in separation amount A to less than the range specified above. When the agitation speed is too low, the mixing period too short or the bead average particle size too large outside the ranges above, the inorganic fine particles A remain as bulky aggregates without pulverization and adhesion on the internal wall of apparatus and on the beads, resulting in decrease in the separation amount A to less than the range specified above.

Alternatively, for example when Henschel Mixer (manufactured by Mitsui Miike Machinery Co., Ltd.) is used, the agitation speed is set to 15 to 40 m/sec, preferably 20 to 30 m/sec and the mixing period to 5 to 30 minutes, preferably 10 to 20 minutes. The separation amount A increases, when the agitation speed is reduced in the range above or the mixing period shortened in the range above. The separation amount A decreases, when the agitation speed is raised in the range above or the mixing period elongated in the range above. When the agitation speed is too high or the mixing period too long outside the ranges above, the inorganic fine particles A are fixed onto the base particles relative tightly, resulting in decrease of the separation amount A below the range specified above. When the agitation speed is too low or the mixing period too short outside the ranges above, the inorganic fine particles A remain as bulky aggregates without pulverization and adheion on the internal wall of the apparatus, resulting in decrease of the separation amount A below the range specified above.

The addition amount of the inorganic fine particles (a) is not particularly limited, if the separation amount A is achieved, but normally, it is preferably 0.1 to 3 wt %, particularly 0.2 to 1 wt % or less, with respect to base particles.

The display particles according to the present invention can also be produced by the following method (B):

Method (B);

In the method (A) above, inorganic fine particles C are fixed onto the base particles previously. Specifically, inorganic fine particles C are pretreated to be fixed on the base particles before the method (A) is carried out. In this way, the inorganic fine particles A function more effectively on the inorganic fine particles C present on the surface of the base particles, resulting in more improvement in decreasing the adhesive force of the display particles to the display particle-contacting surfaces of the substrates and increasing the bearing effect thereof. The “fixing” means a phenomenon that partial regions of the particles are embedded in the base particles so that the inorganic fine particles C are integrated with the base particle,

When the inorganic fine particles C are fixed, most of the inorganic fine particles C are resistant to separation, even when they are exposed to ultrasonic energy under the same conditions as those during measurement of the separation amount A, but the inorganic fine particles C may be separated in the present invention. If the inorganic fine particles C are separated under the conditions above, some of the inorganic fine particles C that have a particular particle size are counted as the inorganic fine particles A during measurement of the separation amount A.

A raw material similar to that for the inorganic fine particles A can be used, except that the particle size of the inorganic fine particles C is not particularly limited, and it is preferably silicon oxide. The inorganic fine particles C commonly used has an average primary particle size of 60 to 250 nm, preferably 70 to 200 nm. The inorganic fine particles C are preferably hydrophobic and preferably have a hydrophobicity in a range similar to that of the inorganic fine particles A.

For example in pretreatment before fixation, base particles and inorganic fine particles C are mixed with each other in a mixer allowing uniform agitation under relative strong agitating force such as Henschel Mixer (manufactured by Mitsui Miike Machinery Co., Ltd.) or Super Mixer (manufactured by Kawata MFG. Co., Ltd.) under relatively high agitation speed for a relatively long mixing period (strong agitation treatment). The agitation speed is adjusted to 30 to 70 m/sec, preferably to 40 to 60 m/sec, and the mixing period is adjusted to 10 to 60 minutes, preferably to 20 to 40 minutes.

In the method (B), it is preferable to carry out a heat-treatment for a short period after the pretreatment and before processing by the method (A). It is for prevention of release of the inorganic fine particles C and expression of the abovementioned effect for an extended period of time. The heat treatment for a short period is heat treatment by blowing hot air instantaneously onto materials to be treated. The heating temperature is adjusted to a temperature allowing fixation and yet preventing complete embedding of the particles and fusion between particles in the same kind, and it can be determined, for example, according to weight-average molecular weight of base particles. Specifically when the weight-average molecular weight of the base particles is approximately 5000 to 200000, the heating temperature is normally, favorably 80 to 300° C. An example of the apparatus allowing such an instantaneous heat treatment is a commercially available hot air sphericalizing apparatus (Surfusing System SFS-3, manufactured by Nippon Pneumatic Mfg. Co., Ltd.).

The addition amount of the inorganic fine particles C is not particularly limited, and it is, for example, preferably 200 wt % or less, particularly 1 to 10 wt % or less, with respect to the base particles.

In the present invention, the display particles normally contains positively and negatively charged display particles and each of any display particles is constituted by base particles and inorganic fine particles externally added thereon. In this case, the separation amounts A, X and B and the relationship thereof of the mixture of the positively and negatively charged display particles are preferably in the ranges above.

The positively and negatively charged display particles can be produced respectively, independently by the method (A) or (B) described above. Preferably, the positively and negatively charged display particles are produced respectively by the method (B).

The positively and negatively charged display particles are respectively electrified to a particular polarity, for example, as they are brought into contact with each other or with a standard charge-providing material such as iron powder (carrier) under friction. The electrification polarity can be controlled, for example, by adjusting kinds of resin and charge-controlling agents contained in the base particles.

Base Particles

The base particles, either in the positively or negatively charged display particles, are colored resin particles containing at least a resin and a colorant, and colorants different in color are contained in the base particles in the positively charged display particles and those in the negatively charged display particles.

The phrase “different in color” means that, when electric field is applied between the substrates in an image display device, which will be described later in detail, there is difference, for example in color tone, brightness, chroma or the like, between the display particles moved and adhered on the substrate present upstream in the visible direction and those moved and adhered on the substrate present downstream in the visible direction. A displayed image is recognized visually, based on such differences. For example, white and black base particles are used in combination. It is possible to control the image color by properly selecting the kinds of the colorants contained in respective base particles (black: carbon black, iron oxide or aniline black, and white: titanium oxide, zinc oxide or zinc sulfide).

The resin for the base particles is not particularly limited, and is typically a polymer called vinyl resin shown below, and examples thereof include, in addition to vinyl resins, condensation resins such as polyamide resins, polyester resins, polycarbonate resins and epoxy resins. Typical examples of the vinyl resins include polystyrene resins, polyacrylic resins, polymethacrylic resins, polyolefin resins from ethylene or propylene monomer, and the like. Examples of the resins other than vinyl resins include, in addition to the condensation resins described above, polyether resins, polysulfone resins, polyurethane resins, fluorine resins, silicone resins and the like.

The polymer constituting the resin for use as the base particles may be a polymer prepared from at least one polymerizable monomer for the resin or a polymer prepared in combination of multiple kinds of polymerizable monomers. When the resin is prepared in combination of multiple kinds of polymerizable monomers, the resin may be a copolymer such as block copolymer, graft copolymer or random copolymer, or a polymer blend that is prepared by blending of multiple kinds of resins.

For example among the resins described above, base particles containing a styrene acrylic resin, an acrylic resin or a fluorine resin tend to be charged negatively, and are thus useful as negatively charged display particles. Alternatively, base particles for example containing a polyamide resin or a polymethacrylic resin tend to be charged positively, and are thus useful as positively charged display particles.

A weight-average molecular weight of the resin constituting the base particles is normally 5000 to 200000, particularly 15000 to 100000.

In the present description, the weight-average molecular weight is a value, as determined by using HLC-8220 (manufactured by Toso Corporation).

The colorant is not particularly limited, and any pigment known in the field of electrophotographic toner may be used. Examples of white pigments for white base particles include zinc oxide (zinc white), titanium oxide, antimony white, zinc sulfide, barium titanate, calcium titanate, strontium titanate and the like, and titanium oxide is preferable among them. Examples of black pigments for black base particles include carbon black, copper oxide, manganese dioxide, aniline black, activated carbon and the like, and carbon black is preferable among them. The content of the colorant is not particularly limited, and may be, for example 1 to 200 parts by weight, with respect to 100 parts by weight of the resin.

The base particles may contain additionally, as needed, a charge-controlling agent that is used in the field of electrophotographic toner.

The charge-controlling agent is not particularly limited, and any charge-controlling agent known in the field of electrophotographic toner may be used. Base particles containing a negative charge-controlling agent such as metal salicylate complex, metal-containing azo dye, quaternary ammonium salt compound or nitroimidazole derivative are useful as those for negatively charged display particles. Alternatively, base particles containing a positive charge-controlling agent such as nigrosine-based dye, triphenylmethane compound or imidazole derivative are useful as those for positively charged display particles. The content of the charge-controlling agent is not particularly limited, and may be, for example 0.1 to 10 parts by weight, with respect to 100 parts by weight of the resin.

A volume-average particle size D1 of the base particles is 1 to 50 μm, preferably 1 to 30 μm. When the positively and negatively charged display particles are used, the volume average diameter D1 of all the base particles, i.e., base particles both for positively and negatively charged display particles, is preferably in the range above. An excessive smaller D1 leads to increase in Van der Waals force and deterioration in contrast because of aggregation of display particles. An excessively large D1 leads to increase in stress during operation under the influence of the own weight of the particles and deterioration in repetition durability because of embedding of the external additives.

The volume-average particle size of the base particles D1 is a volume-standard median diameter (d50 diameter) and can be determined and calculated by using an apparatus having Multisizer 3 (manufactured by Beckman Coulter, Inc.) and a computer for data processing connected thereto.

In the measurement procedure, 0.02 g of a sample is conditioned in 20 ml of a surfactant solution (surfactant solution for dispersion of particles, prepared by diluting a neutral detergent containing a surfactant component ten times with purified water) and dispersed by ultrasonication for 1 minute, to give dispersion liquid. The dispersion is then pipetted into a beaker containing ISOTONII (manufactured by Beckman Coulter, Inc.) on the sample stand table up to a test concentration of 10%, and the volume-average particle size thereof is determined, while the analyzer count is set to 2500 pieces. The aperture diameter of the Multisizer 3 used is 50 μm.

A method of producing the base particles is not particularly limited, and any known method for producing particles containing a resin and a colorant, such as a production method for toners for electrophotographic image formation, may be used. Typical examples of the production methods for the base particles include the followings:

(1) Method for producing base particles through the steps of kneading a resin and a colorant and pulverizing and classifying the mixture;
(2) So-called suspension polymerization method for producing base particles by forming droplets of a polymerizable monomer and a colorant under mechanical agitation in an aqueous medium and polymerizing the droplets; and
(3) So-called emulsion-polymerization aggregation method for producing base particles by adding a polymerizable monomer dropwise into a surfactant-containing aqueous medium, preparing polymer particles of 100 to 150 nm in diameter by polymerization reaction in micelles formed, and then aggregating and fusing these particles by addition of colorant particles and a coagulant.

Image Display Device

The image display device according to the present invention is characterized by being installed by the display particles described above. The image display device according to the present invention will be described in detail. The image display device according to the present invention is a device called “powder display”.

In the image display device according to the present invention, the display particles are sealed in powder form between two substrates, at least one of which is transparent, and the display particles are moved as electric field is applied between the substrates, so that an image is displayed.

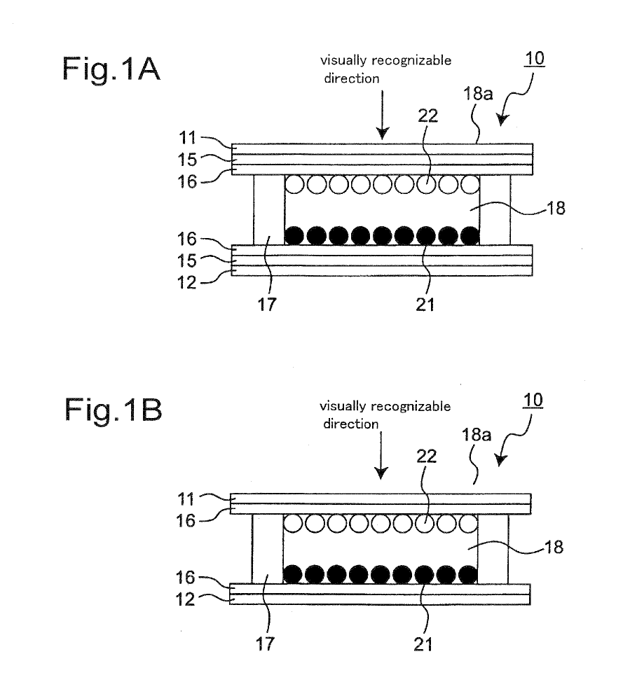

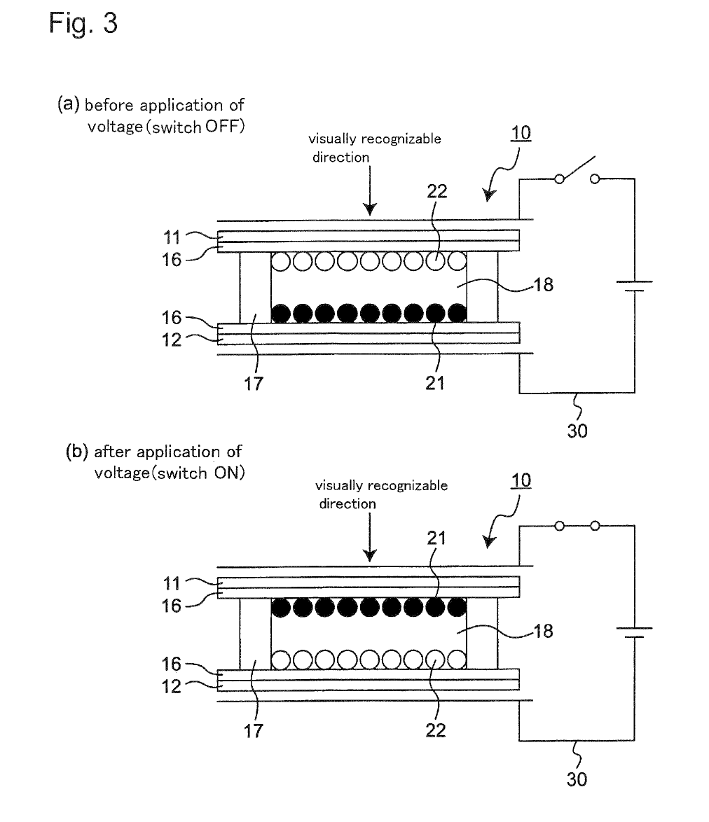

The cross-sectional configuration of a typical example of the image display device according to the present invention is shown in FIG. 1. FIG. 1(a) shows substrates 11 and 12 each having a layer-structured electrode 15 thereon and additionally an insulation layer 16 formed on the surface of the electrode 15. The image display device shown in FIG. 1(b) has a structure with no electrode therein, and the electric field is applied through electrodes formed externally for movement of the display particles. The same number in FIGS. 1(a) and 1(b) indicates the same member. FIG. 1 is a concept including FIGS. 1(a) and 1(b). As shown in the Figure, in the image display device 10 in FIG. 1, an image is recognized visually from the side of substrate 11, but the present invention is not limited to the device of which the image is recognized from the side of substrate 11. The device shown in FIG. 1(b) has an advantage that the structure of the device is simplified because there is no electrode 15 formed in the device and thus the production process can be shortened. FIG. 3 shows the state when a voltage is applied to the image display device 10 of the type shown in FIG. 1(b), as it is connected to an apparatus enabling voltage application. The cross-sectional configuration of the image display device according to the present invention is not limited to those shown in FIGS. 1(a) and 1(b).

Two substrates 11 and 12, casings for the image display device, are placed, as they face each other, at the outmost layer of the image display device 10 of FIG. 1(a). Electrodes 15 for voltage application are formed respectively on the faces of the substrates 11 and 12 facing each other and insulation layers 16 are formed on the electrodes 15. Each of the substrates 11 and 12 has an electrode 15 and an insulation layer 16 formed thereon, and display particles are present in the gap 18 between the faces thereof carrying the electrode 15 and the insulation layer 16 facing each other. The image display device 10 shown in FIG. 1 has two kinds of display particles, black display particles (hereinafter, referred to as black particles) 21 and white display particles (hereinafter, referred to as white particles) 22, in the gap 18. Strictly speaking, the resin fine particles and the inorganic fine particles described above are added externally onto the surfaces of the black particles 21 and the white particles 22, but are not shown in the Figure. The image display device 10 of FIG. 1 has a structure in which the gap 18 is surrounded by the substrates 11 and 12 and two partition walls 17, and the display particles are present in the gap 18 in a sealed state.

The thickness of the gap 18 is not particularly limited, if the sealed display particles are movable and the contrast of the image is preserved, but normally, it is 10 μm to 500 μm, preferably 10 μm to 100 μm. The volume-filling-ratio of the display particles in the gap 18 is 5% to 70%, preferably 30% to 60%. When the volume-filling-ratio of the display particles is in the range above, the display particles can move smoothly in the gap 18, giving a high-contrast image.

The behavior of the display particles in the gap 18 of image display device 10 will be described.

When a voltage is applied and electric field is generated between the two substrates in the image display device according to the present invention, electrostatically charged display particles move along the electric field direction. In this way, application of a voltage between substrates where the display particles are hold leads to move the charged display particles between the substrates, resulting in display of an image.

An image is displayed in the image display device according to the present invention in the following manner:

(1) Display particles for use as display medium is charged electrostatically by a known method such as frictional electrification by using a carrier.
(2) The display particles are sealed between two substrates facing each other and a voltage is applied between the substrates in that state.
(3) Application of the voltage between the substrate forms an electric field between the substrates.
(4) The display particles are attracted toward the surface of the substrate in the electric field direction opposite to the polarity of the display particles, under the force of the electric field formed between the electrodes, permitting image display.
(5) The direction of the electric field between the substrates is altered, so that the moving direction of the display particles is switched, Switching of the traveling direction enables change in image display in various ways.

Examples of the above-described known methods of charging display particles include a method of charging display particles by frictional electrification by contact with a carrier, a method of charging display particles by frictional electrification by mixing two kinds of colored display particles different in electrification polarity and agitating them, and the like, but it is preferable in the present invention to charge display particles by using a carrier and seal them between substrates.

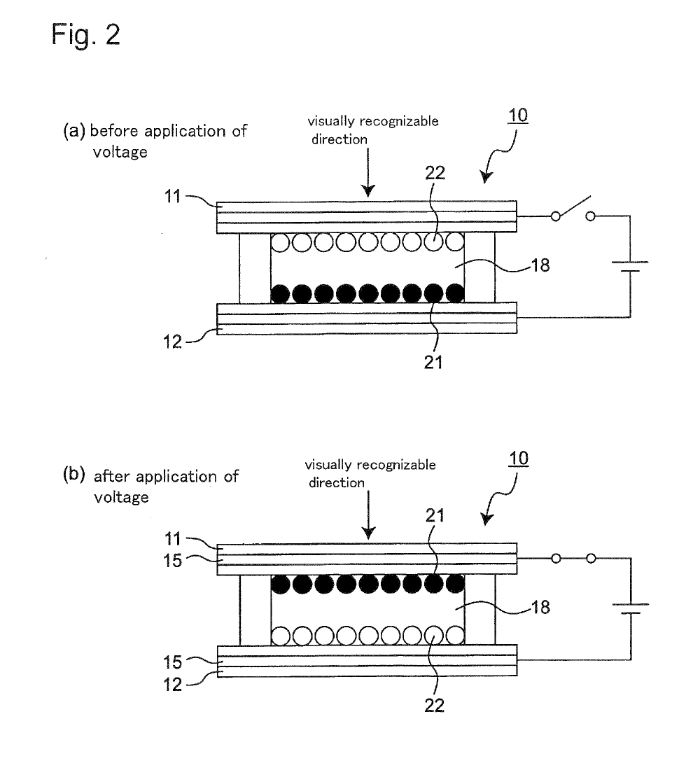

Examples of the migration of the display particles associated with voltage application to the substrates are shown in FIGS. 2 and 3.

FIG. 2(a) shows the state before application of a voltage between the substrates 11 and 12, and positively charged white particles 22 are present in the region close to the substrate 11 on the visible side before application of a voltage. The image display device 10 displays a white image in this state. FIG. 2(b) shows the state after application of a voltage to the electrodes 15, demonstrating that application of a positive voltage to the substrate 11 results in migration of negatively charged black particles 21 to the region close to the substrate 11 on the visible side and migration of the white particles 22 to the side of the substrate 12. The image display device 10 displays a black image in this state.

FIG. 3 shows the state before voltage application (FIG. 3(a)) and the state after voltage application (FIG. 3(b)), when the image display device 10 shown in FIG. 1(b) without electrode is connected to a voltage application apparatus 30. In the image display device 10 of the type shown in FIG. 1(b), when a positive voltage is applied to the substrate 11, negatively charged black particles 21 migrate into the region close to the substrate 11 on the visible side and positively charged white particles 22 to the side of the substrate 12, similarly to the image display devices 10 having electrodes 15.

Hereinafter, the substrates 11 and 12, the electrodes 15, and the insulation layers 16 and the partition walls 17 constituting the image display device 10 shown in FIG. 1 will be described.

First, the substrates 11 and 12 constituting the image display device 10 will be described. In the image display device 10, because the viewer recognizes visually the images formed by the display particles at least from one side of the substrates 11 and 12, the substrate formed to the viewer recognition side should be made of a transparent material. Thus, the substrate for use on the visible side from the viewer is preferably a light-transmitting material, for example having a visible light transparency of 80% or more, and a visible light transparency of 80% or more gives sufficient visibility. In the substrates for the image display device 10, the material for the substrate formed on the side opposite to the image recognition side may not be transparent.

The thickness of the substrate 11 or 12 is preferably 2 μm to 5 mm, more preferably 5 μm to 2 mm. When the thickness of the substrate 11 or 12 is in the range above, the image display device 10 is strong enough and can hold the gap between the substrates uniformly. It is possible by adjusting the thickness of the substrate in the range above to provide a compact and light-weight image display device and accelerate use of the image display device in wider applications. In addition when the thickness of the image recognition-sided substrate is in the range above, it is possible to visually recognize the display image accurately, as favorable display quality is preserved.

Examples of the materials having a visible light transparency of 80% or more include non-flexible inorganic materials such as glass and quartz, organic materials such as the resin materials described below, and metal sheets and the like. Among the materials above, organic materials and metal sheets can provide the image display device flexibility to some extent. Examples of the resin materials having a visible light transparency of 80% or more include polyester resins such as polyethylene terephthalate and polyethylene naphthalate, polycarbonate resins, polyether sulfone resins, polyimide resins and the like. Other examples include acrylic resins, i.e., polymers of an acrylic or methacrylic ester such as polymethyl methacrylate (PMMA), transparent resins obtained by radical polymerization of a vinyl polymerizable monomer such as polyethylene resins.

The electrodes 15 formed on the substrates 11 and 12 generate electric field between the substrate, i.e., in the gap 18 by application of a voltage. Similarly to the substrates described above, a transparent electrode should be formed as the electrode 15 on the side where a viewer recognizes images.

A thickness of the electrode formed on the image-recognizing side is required to be adjusted to a level enough to assure conductivity and to prevent undesired deterioration in light-transmitting efficiency thereof, and specifically, it is preferably 3 nm to 1 μm, more preferably 5 nm to 400 nm. The visible light transparency of the electrode formed on the image-recognizing side is preferably 80% or more, similarly to the substrate above. A thickness of the electrode formed on the side opposite to the image-recognizing side is also preferably in the range above, but this electrode may not be transparent.

The material constituting the electrode 15 may be a metal material, a conductive metal oxide, a conductive polymeric material or the like. Typical examples of the metal materials include aluminum, silver, nickel, copper, gold and the like, and typical examples of the conductive metal oxides include indium tin oxide (ITO), indium oxide, antimony tin oxide (ATO), tin oxide, zinc oxide and the like. Examples of the conductive polymeric materials include polyaniline, polypyrrole, polythiophene, polyacetylene and the like.

Methods for forming the electrode 15 on the substrates 11 and 12, when it is a thin-film electrode, include for example, sputtering, vacuum deposition, chemical vapor deposition (CVD), coating and the like. Also included is a method for forming an electrode by mixing a conductive material with a solvent and a binder resin and applying the mixture on a substrate.

The insulation layer 16 is formed on the surface of the electrode 15, and the display particles 21 and 22 are in contact with the surface of the insulation layer 16, but such an insulation layer may not necessarily be formed. The insulation layer 16 has a role to suppress fluctuation in charge caused by application of the voltage for migration of the display particles 21 and 22. The insulation layer, if it is made of a resin having a highly hydrophobic structure and if it is surface-roughened, can reduce physical adhesive force to the display particles and thus has an action to reduce the operational voltage. The material constituting the insulation layer 16 is an electrically insulating material that can be formed into a thin film, which may be transparent as needed. The insulation layer formed on the image-recognizing side preferably has a visible light transparency of 80% or more, similarly to the substrate. Typical examples thereof include silicone resins, acrylic resins, polycarbonate resins and the like.

A thickness of the insulation layer 16 is preferably 0.01 μm or more and 10.0 μm or less. When the thickness of the insulation layer 16 is in the range above, the display particles 21 and 22 can be moved, even when a not high voltage is applied between the electrodes 15, and, for example, an image can be favorably displayed, when a voltage at the level applied during image formation in the electrophoretic mode is applied.

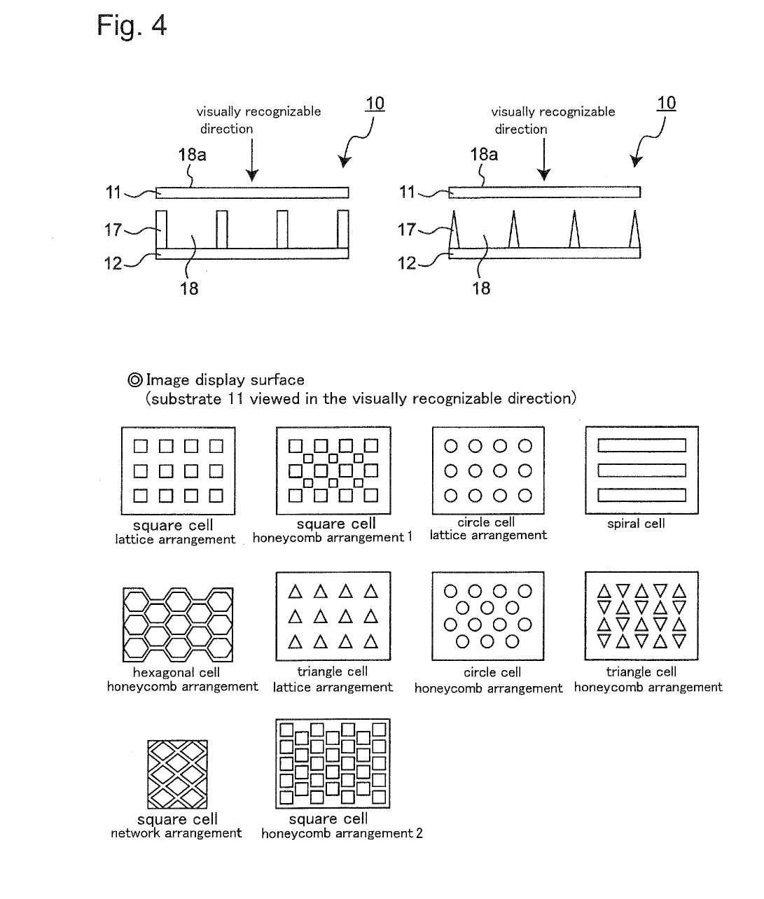

The partition wall 17 is to assure the gap 18 between the upper and bottom substrates, and as shown in the top right and top left sides of FIG. 4, the partition walls can be formed not only on the edges of the substrates 11 and 12, but also on the internal regions as needed. The width of the partition wall 17, in particular the thickness of the partition wall towards the side of the image displaying surface 18a is preferably thinner as much as possible, for example as shown in the top right figure of FIG. 4, for assuring favorable definition of the display image.

The partition walls 17 in the internal regions of the substrates 11 and 12 may be formed continuously or intermittently in the front-rear direction in the top right and left figures of FIG. 4.

It is possible to modify shapes of cells divided by the partition walls 17 in the gap 18 in various ways, by controlling the shape and position of the partition walls 17. Examples of the shapes and the positions of the cells, when the gap 18 is seen from the side of substrate 11, are shown in the bottom figure of FIG. 4. As shown in the bottom figure of FIG. 4, the cell may be square, triangular, linear, circular, hexagonal or the like, and multiple cells may be formed in a honeycomb or network pattern.

The partition walls 17 can be formed by processing the substrate in the side opposite to the image-recognizing side by, for example, a method described below. Examples of the methods for forming the partition walls 17 include a surface-irregular processing, such as embossing with a resin material and heat press injection molding, a photolithographic method, a screen printing method and the like.

### EXAMPLES

### Example 1

Preparation of White Display Particles

White Base Particle

The resin and titanium oxide described below were placed in a Henschel mixer (manufactured by Mitsui Miike Machinery Co., Ltd.) and mixed therein with an agitating-blade peripheral speed adjusted to 25 m/sec for 5 minutes, to give a mixture.

| | |
|---|---|
| Styrene acrylic resin (weight-average | 100 parts by weight |
| molecular weight: 20,000) | |
| Anatase titanium oxide (average primary | 30 parts by weight |
| particle size: 150 nm) | |

The mixture of the above was placed and kneaded in a biaxial extrusion kneader, pulverized coarsely in a hammer mill, then pulverized finely in a turbo mill pulvelizer (manufactured by Turbo Kogyo) and further classified in an air classifier utilizing Coanda effect, to give white base particles having a volume-average diameter of 10.0 μm.

Pretreatment

Five parts by weight of silica particles (hydrophobicity: 75%) having an average primary particle size of 100 nm treated with an aminosilane-based coupling agent (aminopropyltrimethoxysilane) were added to 100 parts by weight of the white base particles and the mixture was placed in a Henschel Mixer (manufactured by Mitsui Miike Machinery Co., Ltd.) and mixed for 30 minutes with an agitating-blade peripheral speed (agitation speed) adjusted to 55 m/sec.

Instantaneous Heat Treatment

Then, the mixture obtained was heat-treated instantaneously in a hot air-spherizing apparatus (Surfusing System SFS-3, manufactured by Nippon Pneumatic Mfg. Co., Ltd.) at an inlet hot air temperature of 100° C., a hot air flow rate of 1.0 m³ and a raw material feed rate of 1.0 kg/h for a hot air treatment period of 0.03 s.

Mild-Condition Mixing-Treatment

Subsequently, the mixture obtained, 0.4 part by weight of silica particles (hydrophobicity 78%) having an average primary particle size of 15 nm treated with an aminosilane-based coupling agent (aminopropyltrimethoxysilane) and 300 parts by weight of glass beads having an average primary particle size of 1 mm were placed in a 500-cc pot, and mixed in a Turbula mixer (manufactured by Glen Mills Inc.) at 100 rpm for 5 minutes. The mixture obtained was filtered through a mesh sieve for removal of the glass beads to give white display particles. The content of the primary particles having a primary particle size of 5 to 60 nm in the silica particles was 80 wt %.

Preparation of Black Display Particles

Black Base Particle

The resin described below and carbon black were placed in a Henschel mixer (manufactured by Mitsui Miike Machinery Co., Ltd.) and mixed therein with an agitating-blade peripheral speed adjusted to 25 m/sec for 5 minutes, to give a mixture.

| | |
|---|---|
| Styrene acrylic resin (weight-average | 100 parts by weight |
| molecular weight: 20,000) | |
| Carbon black (average primary particle | 10 parts by weight |
| size: 25 nm) | |

The mixture above was kneaded in a biaxial extrusion kneader, pulverized coarsely in a hammer mill, pulverized finely in a turbo mill pulverizer (manufactured by Turbo Kogyo) and classified in an air classifier utilizing Coanda effect, to give black base particles having a volume-average diameter of 10.0 μm.

Pretreatment

Five parts by weight of silica particles (hydrophobicity: 88%) having an average primary particle size of 100 nm treated with a silazane-based coupling agent hexamethyldisilazane were added to 100 parts by weight of the black base particles, and the mixture was placed in a Henschel Mixer (manufactured by Mitsui Miike Machinery Co., Ltd.) and mixed therein for 30 minutes with an agitating-blade peripheral speed (agitation speed) adjusted to 55 m/sec.

Instantaneous Heat Treatment

Then, the mixture obtained was heat-treated instantaneously in a hot air-spherizing apparatus (Surfusing System SFS-3, manufactured by Nippon Pneumatic Mfg.) at an inlet hot air temperature of 100° C., a hot air flow rate of 1.0 m³ and a raw material feed rate of 1.0 kg/h for a hot air treatment period of 0.03 s.

Mild-Condition Mixing-Treatment

Subsequently, the mixture obtained, 0.4 part by weight of silica particles (hydrophobicity 92%) having an average primary particle size of 15 nm treated with a silazane-based coupling agent hexamethyldisilazane and 300 parts by weight of glass beads having an average primary particle size of 1 mm were placed in a 500-cc pot, and were mixed in a Turbula mixer (manufactured by Glen Mills Inc.) at 100 rpm for 5 minutes. The mixture obtained was filtered through a mesh sieve for removal of the glass beads to give black display particles. The content of the primary particles having a primary particle size of 5 to 60 nm in the silica particles was 82 wt %.

Carrier A for Charging White Display Particles

Two parts of fluorinated acrylate resin particles were added to 100 parts by weight of ferrite cores having an average particle size of 80 μm; these materials were placed in a horizontal rotor-blade mixer and mixed therein under the conditions of a horizontal rotor-blade peripheral speed of 8 m/sec at 22° C. for 10 minutes and then, heated to 90° C. and agitated for 40 minutes, to give a carrier A.

Carrier B for Charging Black Display Particles

Two parts of cyclohexyl methacrylate resin particles were added to 100 parts by weight of ferrite cores having an average particle size of 80 μm; these materials were placed in a horizontal rotor-blade mixer and mixed therein under the conditions of a horizontal rotor-blade peripheral speed of 8 m/sec at 22° C. for 10 minutes and then, heated to 90° C. and agitated for 40 minutes, to give a carrier B.

Preparation of Image Display Device

An image display device having a structure similar to that shown in FIG. 1(a) was prepared in the following manner: Two glass plates 11 of 80 mm in length, 50 mm in width and 0.7 mm in thickness were prepared. An electrode 15 of an indium tin oxide (ITO) film having a thickness of 300 nm (resistance 30Ω/□) was formed on the surface of each substrate by vapor deposition. A coating solution prepared by dissolving 12 g of a polycarbonate resin in a mixed solvent of 80 ml of tetrahydrofuran and 20 ml of cyclohexanone was applied on the electrode by spin coating, forming an insulation layer 16 having a thickness of 3 μm thereon, to give a pair of electrode-carrying substrates.

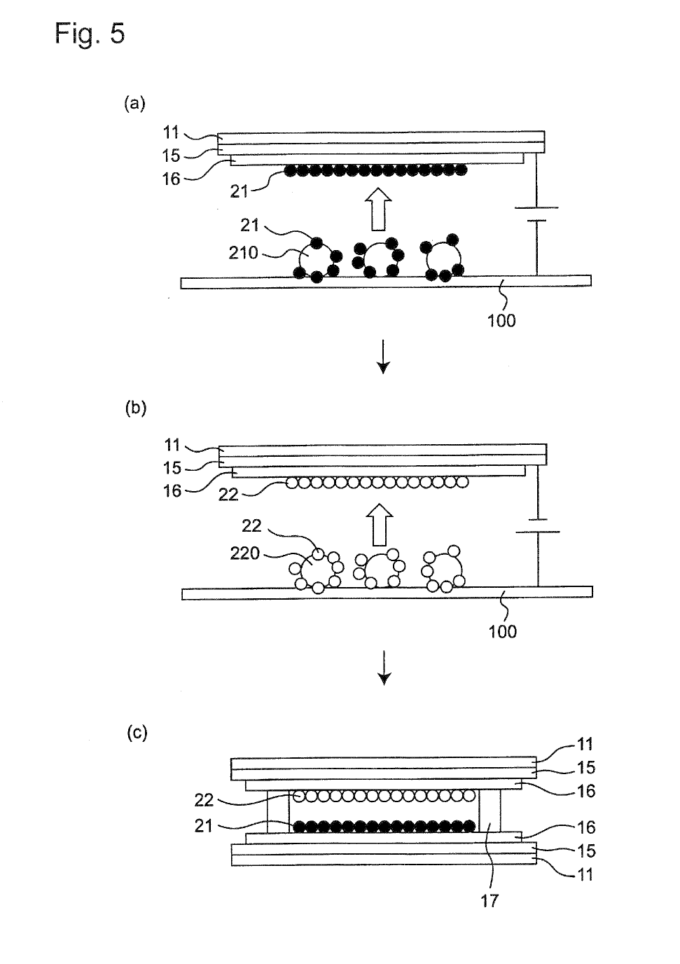

One g of the black display particles and 9 g of the carrier B were mixed in a shaker (YS-LD, manufactured by Yayai) for 30 minutes, to charge the display particles electrically. As shown in FIG. 5(a), the mixture obtained (21 or 210), was placed on a conductive stage 100 and one electrode-carrying substrate was placed at a position separated by approximately 2 mm from the stage 100. A DC bias voltage of +50 V and an AC bias voltage of 2.0 kV, a frequency of 2.0 kHz were applied between the electrode 15 and the stage 100 for 10 seconds, for adhesion of the black display particles 21 on the insulation layer 16.

One g of the white display particles and 9 g of the carrier A were mixed in a shaker (YS-LD, manufactured by Yayoi) for 30 minutes, to charge display particles electrically. As shown in FIG. 5(b), the mixture obtained (22 or 220), was placed on a conductive stage 100 and one electrode-carrying substrate was placed at a position separated by approximately 2 mm from the stage 100. A DC bias voltage of −50 V and an AC bias voltage of 2.0 kV, a frequency of 2.0 kHz were applied between the electrode 15 and the stage 100 for 10 seconds, for adhesion of the white display particles 22 on the insulation layer 16.

The electrode-carrying substrate having the black display particles adhered thereto and the electrode-carrying substrate having the white display particles adhered thereto were stacked as separated from each other at an gap of 50 μm by partition walls, as shown in FIG. 5(c), and the area surrounding the substrate was sealed with an epoxy-based adhesive, to give an image display device. The volume-filling-ratio of the two kinds of display particles in the area between the glass plates was 50%. The content ratio of the white display particles and the black display particles was approximately 1/1 as white display particles/black display particles by number.

### Example 2

An image display device was prepared in a manner similar to Example 1, except that the white and black display particles prepared by the following methods were used.

Preparation of White Display Particles

Mild-Condition Mixing-Treatment

One hundred parts by weight of the white base particles similar to those in Example 1, 0.4 part by weight of silica particles (hydrophobicity: 78%) having an average primary particle size of 15 nm treated with an aminosilane-based coupling agent (aminopropyltrimethoxysilane) and 300 parts by weight of glass beads having an average primary particle size of 1 mm were placed in a 500-cc pot, and mixed with a Turbula mixer (manufactured by Glen Mills Inc.) at 100 rpm for 5 minutes. The mixture obtained was filtered through a mesh sieve for removal of the glass beads to give white display particles. The content of the primary particles having a primary particle size of 5 to 60 nm in the silica particles was 80 wt %.

Preparation of Black Display Particles

Mild-Condition Mixing-Treatment

One hundred parts by weight of the black base particles similar to those in Example 1, 0.3 part by weight of silica particles (hydrophobicity: 92%) having an average primary particle size of 15 nm treated with an silazane-based coupling agent hexamethyldisilazane and 300 parts by weight of glass beads having an average primary particle size of 1 mm were placed in a 500-cc pot and mixed with a Turbula mixer (manufactured by Glen Mills Inc.) at 100 rpm for 5 minutes. The mixture obtained was filtered through a mesh sieve for removal of the glass beads to give black display particles. The content of the primary particles having a primary particle size of 5 to 60 nm in the silica particles was 82 wt %

### Examples 3 to 6 and Comparative Examples 1 to 6

Image display devices were prepared in a manner similar to Example 2, except that the white and black display particles prepared by the following methods were used.

Preparation of White and Black Display Particles

White and black display particles were prepared respectively in a manner similar to the preparation of white and black display particles of Example 2, except that the mild-condition mixing-treatment was performed under the conditions shown in the Table.

### Examples 7 to 9 and Comparative Example 7

Image display devices were prepared in a manner similar to Example 1, except that the white and black display particles prepared by the following method were used:

Preparation of White and Black Display Particles

White and black display particles were prepared respectively in a manner similar to the preparative method for the white and black display particles of Example 1, except that the pretreatment and the mild-condition mixing-treatment were performed under the conditions shown in the Table.

TABLE 1

| | | | Example 1 | Example 2 | Example 3 | Example 4 | Example 5 | Example 6 | Example 7 | Example 8 | Example 9 |
|---|---|---|---|---|---|---|---|---|---|---|---|
| White | Pre- | Mixer | Henschel | — | — | — | — | — | Henschel | Henschel | Henschel |
| display | treatment | | Mixer | | | | | | Mixer | Mixer | Mixer |
| particle | | Mixing speed | 55 m/sec | — | — | — | — | — | 55 m/sec | 55 m/sec | 55 m/sec |
| | | Mixing period | 30 | — | — | — | — | — | 30 | 30 | 30 |
| | | | minutes | | | | | | minutes | minutes | minutes |
| | | Inorganic fine | | | | | | | | | |
| | | particles C: | | | | | | | | | |
| | | Average primary | 100 nm | | | | | | 100 nm | 100 nm | 100 nm |
| | | particle size | | — | — | — | — | — | | | |
| | | Addition amount | 5 parts | | | | | | 5 parts | 5 parts | 5 parts |
| | Mild- | Mixer | Turbular | Turbular | Turbular | Turbular | Henschel | Henschel | Turbular | Turbular | Turbular |
| | condition | | mixer | mixer | mixer | mixer | Mixer | Mixer | mixer | mixer | mixer |
| | mixing | Mixing speed | 100 rpm | 100 rpm | 300 rpm | 20 rpm | 20 m/sec | 15 m/sec | 100 rpm | 100 rpm | 100 rpm |
| | treatment | Mixing period | 5 | 5 | 20 | 3 | 15 | 5 | 5 | 5 | 5 |
| | | | minutes | minutes | minutes | minutes | minutes | minutes | minutes | minutes | minutes |
| | | Inorganic fine | | | | | | | | | |
| | | particles a: | | | | | | | | | |
| | | Average primary | 15 nm | 15 nm | 15 nm | 15 nm | 15 nm | 15 nm | 15 nm | 30 nm | 40 nm |
| | | particle size | | | | | | | | | |
| | | Addition amount | 0.4 parts | 0.4 parts | 0.4 parts | 0.4 parts | 0.4 parts | 0.4 parts | 3 parts | 3 parts | 3 parts |
| Black | Pre- | Mixer | Henschel | — | — | — | — | — | Henschel | Henschel | Henschel |
| display | treatment | | Mixer | | | | | | Mixer | Mixer | Mixer |
| particle | | Mixing speed | 55 m/sec | — | — | — | — | — | 55 m/sec | 55 m/sec | 55 m/sec |
| | | Mixing period | 30 | — | — | — | — | — | 30 | 30 | 30 |
| | | | minutes | | | | | | minutes | minutes | minutes |
| | | Inorganic fine | | | | | | | | | |
| | | particles C: | | | | | | | | | |
| | | Average primary | 100 nm | | | | | | 100 nm | 100 nm | 100 nm |
| | | particle size | | — | — | — | — | — | | | |
| | | Addition amount | 5 parts | | | | | | 5 parts | 5 parts | 5 parts |
| | Mild- | Mixer | Turbular | Turbular | Turbuiar | Turbular | Henschel | Henschel | Turbular | Turbular | Turbular |
| | condition | | mixer | mixer | mixer | mixer | Mixer | Mixer | mixer | mixer | mixer |
| | mixing | Mixing speed | 100 rpm | 100 rpm | 300 rpm | 20 rpm | 20 m/sec | 15 m/sec | 100 rpm | 100 rpm | 100 rpm |
| | treatment | Mixing period | 5 | 5 | 20 | 3 | 15 | 5 | 5 | 5 | 5 |
| | | | minutes | minutes | minutes | minutes | minutes | minutes | minutes | minutes | minutes |
| | | Inorganic fine | | | | | | | | | |
| | | particles a: | | | | | | | | | |
| | | Average primary | 15 nm | 15 nm | 15 nm | 15 nm | 15 nm | 15 nm | 15 nm | 30 nm | 40 nm |
| | | particle size | | | | | | | | | |
| | | Addition amount | 0.4 parts | 0.4 parts | 0.4 parts | 0.4 parts | 0.4 parts | 0.4 parts | 3 parts | 3 parts | 3 parts |

TABLE 2

| | | | Comparative | Comparative | Comparative | Comparative | Comparative | Comparative | Comparative |
|---|---|---|---|---|---|---|---|---|---|
| | | | Example 1 | Example 2 | Example 3 | Example 4 | Example 5 | Example 6 | Example 7 |
| White | Pre- | Mixer | — | — | — | — | — | — | Henschel |
| display | treatment | | | | | | | | Mixer |
| particle | | Mixing speed | — | — | — | — | — | — | 55 m/sec |
| | | Mixing period | — | — | — | — | — | — | 30 |
| | | | | | | | | | minutes |
| | | Inorganic fine | | | | | | | |
| | | particles C: | | | | | | | |
| | | Average primary | — | — | — | — | — | — | 100 nm |
| | | particle size | | | | | | | |
| | | Addition amount | | | | | | | 5 parts |
| | Mild- | Mixer | Henschel | Henschel | Turbular | Turbular | Turbular | Turbular | Henschel |
| | condition | | Mixer | Mixer | mixer | mixer | mixer | mixer | Mixer |
| | mixing | Mixing speed | 55 m/sec | 10 m/sec | 100 rpm | 15 rpm | 100 rpm | 100 rpm | 55 m/sec |
| | treatment | Mixing period | 30 | 5 | 5 | 5 | 25 | 5 | 30 |
| | | | minutes | minutes | minutes | minutes | minutes | minutes | minutes |
| | | Inorganic fine | | | | | | | |
| | | particles a: | | | | | | | |
| | | Average primary | 15 nm | 15 nm | 60 nm | 15 nm | 15 nm | 15 nm | 15 nm |
| | | particle size | | | | | | | |
| | | Addition amount | 0.4 parts | 0.4 parts | 3 parts | 0.4 parts | 0.4 parts | 3.5 parts | 0.4 parts |
| Black | Pre- | Mixer | — | — | — | — | — | — | Henschel |
| display | treatment | | | | | | | | Mixer |
| particle | | Mixing speed | — | — | — | — | — | — | 55 m/sec |
| | | Mixing period | — | — | — | — | — | — | 30 |
| | | | | | | | | | minutes |
| | | Inorganic fine | | | | | | | |
| | | particles C: | | | | | | | |
| | | Average primary | — | — | — | — | — | — | 100 nm |
| | | particle size | | | | | | | |
| | | Addition amount | | | | | | | 5 parts |
| | Mild- | Mixer | Henschel | Henschel | Turbular | Turbular | Turbular | Turbular | Henschel |
| | condition | | Mixer | Mixer | mixer | mixer | mixer | mixer | Mixer |
| | mixing | Mixing speed | 55 m/sec | 10 m/sec | 100 rpm | 15 rpm | 100 rpm | 100 rpm | 55 m/sec |
| | treatment | Mixing period | 30 | 5 | 5 | 3 | 25 | 5 | 30 |
| | | | minutes | minutes | minutes | minutes | minutes | minutes | minutes |
| | | Inorganic fine | | | | | | | |
| | | particles a: | | | | | | | |
| | | Average primary | 15 nm | 15 nm | 60 nm | 15 nm | 15 nm | 15 nm | 15 nm |
| | | particle size | | | | | | | |
| | | Addition amount | 0.4 parts | 0.4 parts | 3 parts | 0.4 parts | 0.4 parts | 3.5 parts | 0.4 parts |

The inorganic fine particles having an average primary particle size of 30 nm used in production of the white display particles are silica particles (hydrophobicity: 80%) surface-treated with aminopropyltrimethoxysilane. The content of the primary particles having a primary particle size of 5 to 60 nm was 72 wt %.

The inorganic fine particles having an average primary particle size of 40 nm used in production of the white display particles were silica particles (hydrophobicity: 78%) surface-treated with aminopropyltrimethoxysilane. The content of the primary particles having a primary particle size of 5 to 60 nm was 58 wt %.

The inorganic fine particles having an average primary particle size of 60 nm used in production of the white display particles were silica particle (hydrophobicity: 76%) surface-treated with aminopropyltrimethoxysilane. The content of the primary particles having a primary particle size of 5 to 60 nm was 32 wt %.

The inorganic fine particles having an average primary particle size of 30 nm used in production of the black display particle were silica particles (hydrophobicity: 90%) surface-treated with hexamethyldisilazane. The content of the primary particles having a primary particle size of 5 to 60 nm was 75 wt %.

The inorganic fine particles having an average primary particle size of 40 nm used in production of the black display particles were silica particles (hydrophobicity: 88%) surface-treated with hexamethyldisilazane. The content of the primary particles having a primary particle size of 5 to 60 nm was 61 wt %.

The inorganic fine particles having an average primary particle size of 60 nm used in production of the black display particles were silica particles (hydrophobicity: 89%) surface-treated with hexamethyldisilazane. The content of the primary particles having a primary particle size of 5 to 60 nm was 34 wt %.

Evaluation

A DC voltage was applied to a image display device according to the following procedure, and the display characteristics of the device were evaluated by measurement of reflection density of the display image obtained by application of a voltage. The voltage was applied according to the following procedure. The voltage applied was changed from 0 V, toward positive side and then to negative side, and then back to 0 V so that the voltage was applied in a pattern drawing a hysteresis curve.

(1) a voltage is applied gradually while it is raised from 0 V to +100 V at an interval of 20 V,
(2) a voltage is applied gradually while it is lowered from +100 V to −100 V at an interval of 20 V, and
(3) a voltage is applied gradually while it is raised from −100 V to 0 V at an interval of 20 V.

It was verified that, when a DC voltage was applied to each image display device according to the procedure above, the color of the display changed from white to black when the positive voltage was applied in the white display state. The voltage applied to the electrode located upstream of the image display device in the visible direction was changed and the other electrode was electrically grounded. The density was determined by using a reflection densitometer “RD-918 (manufactured by Macbeth Co.)”.

In evaluation of the device, contrast and repetition characteristics were tested as display characteristics.

Contrast

The contrast was evaluated, based on the difference in color density between black color density and white color density, i.e., the difference in density defined by the following formula:

Contrast=density of black color−density of white color.

The black color density is a reflection density of display surface obtained when a voltage of +100 V was applied to the electrode upstream of the image display device in the visible direction.

The white color density is a reflection density of display surface obtained when a voltage of −100 V was applied to the electrode upstream of the image display device in the visible direction.

The density was an average of measured values at five points on the display surface, as determined by using the reflection densitometer “RD-918 (manufactured by Macbeth Co.)”.

The contrast was ranked as follows;

most favorable (⊙) when the density difference was 1.30 or more, favorable (◯) when it was 1.20 or more,

satisfactory (Δ) when it was 1.00 or more, and

unsatisfactory (x) when it was less than 1.00.

Repetition Characteristics

The repetition characteristics were evaluated, based on the repetition number until the contrast becomes 0.70 or less when voltages of +100 V and −100 V were applied alternately and the reflection density was monitored each time. The repetition number of 5000 or more is ranked as favorable (◯), the number of 1000 or more, as satisfactory (Δ), and the number of less than 1000, as unsatisfactory (x).

Minimum Operating Voltage

The minimum operating voltage is a voltage at which the display density becomes 0.7 or more when the applied voltage is changed from 0 V to 200 V at an interval of 5 V. A minimum operating voltage of 60 V or less is ranked as most favorable (⊙), a voltage of 80 V or less, as favorable (◯), a voltage of 100 V or less, as satisfactory (Δ), and a voltage of more than 100 V, as unsatisfactory (x).

TABLE 3

| | Separation | Separation | | Minimum | | Contrast | | |
|---|---|---|---|---|---|---|---|---|
| | amount A | amount X | | operating voltage | | Difference | | Repetition |
| | (wt %) | (wt %) | A/X | Value (V) | Evaluation | in density | Evaluation | durability |
| Example 1 | 0.27 | 4.88 | 0.055 | 60 | ⊚ | 1.43 | ⊚ | ◯ |
| Example 2 | 0.26 | 0.36 | 0.722 | 80 | ◯ | 1.15 | Δ | ◯ |
| Example 3 | 0.17 | 0.35 | 0.486 | 100 | Δ | 1.12 | Δ | ◯ |
| Example 4 | 0.32 | 0.36 | 0.889 | 80 | ◯ | 1.08 | Δ | ◯ |
| Example 5 | 0.16 | 0.35 | 0.444 | 100 | Δ | 1.01 | Δ | ◯ |
| Example 6 | 0.22 | 0.35 | 0.629 | 90 | Δ | 1.11 | Δ | ◯ |
| Example 7 | 2.48 | 7.42 | 0.334 | 80 | ◯ | 1.25 | ◯ | ◯ |
| Example 8 | 1.86 | 7.24 | 0.257 | 90 | Δ | 1.18 | Δ | ◯ |
| Example 9 | 0.91 | 7.07 | 0.129 | 100 | Δ | 1.09 | Δ | ◯ |
| Comparative | 0.05 | 0.36 | 0.139 | 150 | X | 0.75 | X | Δ |
| Example 1 | | | | | | | | |
| Comparative | 0.07 | 0.35 | 0.200 | 125 | X | 0.90 | X | Δ |
| Example 2 | | | | | | | | |
| Comparative | 0.08 | 2.55 | 0.031 | 130 | X | 0.95 | X | X |
| Example 3 | | | | | | | | |
| Comparative | 0.06 | 0.37 | 0.162 | 145 | X | 0.82 | X | Δ |
| Example 4 | | | | | | | | |
| Comparative | 0.08 | 0.35 | 0.229 | 130 | X | 0.92 | X | Δ |
| Example 5 | | | | | | | | |
| Comparative | 2.88 | 3.14 | 0.917 | 100 | Δ | 0.88 | X | X |
| Example 6 | | | | | | | | |
| Comparative | 0.04 | 4.82 | 0.008 | 115 | X | 0.90 | X | Δ |
| Example 7 | | | | | | | | |

1. Display particles for an image display device in which the display particles are sealed in a powdery form in the space between two substrates, at least one of which is transparent, and an image is displayed while the display particles are moved as electric field is generated between the substrates, characterized in that
the display particles comprise base particles containing at least a resin and a colorant, and inorganic fine particles added to the base particle externally, and
a separation amount A of the inorganic fine particles having a primary particle size of 5 to 60 nm separated from the display particles when the particles are provided with an ultrasonic energy of 60 μA for 1 minute in aqueous polyoxyethylphenylether solution is 0.1 to 2.5 wt % with respect to the base particles.

2. The display particles for an image display device according to claim 1, wherein the separation amount X of all inorganic fine particles separated from the display particles when the particles are provided with an ultrasonic energy of 300 μA for 60 minutes in aqueous polyoxyethylphenylether solution is 0.1 to 20 wt % with respect to the base particles.

3. The display particles for an image display device according to claim 2, wherein a ratio of separation amount A/separation amount X is 0.01 to 0.99.

4. An image display device, in which display particles are sealed in a powdery form in the space between two substrates, at least one of which is transparent, and an image are displayed while the display particles are moved as electric field is generated between the substrates, characterized in that:
the display particles comprise a base particle containing at least a resin and a colorant, and inorganic fine particles added to the base particle externally; and
the separation amount A of the inorganic fine particles having a primary particle size of 5 to 60 nm separated from the display particles when the particles are provided with an ultrasonic energy of 60 μA for 1 minute in aqueous polyoxyethylphenylether solution is 0.1 to 2.5 wt % with respect to the base particles.

5. The image display device according to claim 4, wherein the separation amount X of all inorganic fine particles separated from the display particles when the particles are provided with an ultrasonic energy of 300 μA for 60 minutes in aqueous polyoxyethylphenylether solution is 0.1 to 20 wt % with respect to the base particles.

6. The image display device according to claim 5, wherein a ratio of separation amount A/separation amount X is 0.01 to 0.99.
